(19) United States
(12) Patent Application Publication
(10) Pub. No.: US 2024/0391104 A1
(43) Pub. Date: Nov. 28, 2024

(54) Methods of Handling Safety of Industrial Robot, Control Systems, and Robot System

(71) Applicant: ABB Schweiz AG, Baden (CH)

(72) Inventors: Jonas Brönmark, Västerås (SE); Björn Löfvendahl, Västerås (SE); Stefan Romberg, Västerås (SE); Simon Gräsberg, Västerås (SE)

(21) Appl. No.: 18/695,858

(22) PCT Filed: Oct. 19, 2021
(86) PCT No.: PCT/EP2021/078925

§ 371 Date: Mar. 27, 2024

(51) Int. Cl. B25J 9/16; B25J 19/02

(52) U.S. Cl. CPC B25J 9/1676; B25J 19/023

(57) ABSTRACT

A method of handling safety of an industrial robot, the method including providing at least one virtual safety border defined in relation to the industrial robot, where each virtual safety border is associated with a condition to be fulfilled by the industrial robot; obtaining environment data of a physical environment of the industrial robot by means of an environment sensor; determining, by a control system, an obstacle position of an obstacle in the environment based on the environment data; and evaluating, by the control system, a border position of each virtual safety border with regard to the obstacle position. Control systems for handling safety of an industrial robot in an environment, and a method including defining at least one virtual safety border in relation to the industrial robot based on the environment data, are also provided.

### TECHNICAL FIELD

The present disclosure generally relates to safety of industrial robots. In particular, methods of handling safety of an industrial robot, control systems for handling safety of an industrial robot, and a robot system, are provided.

### BACKGROUND

A robot system may comprise one or several industrial robots operating in an environment. In some robot systems, the environment is enclosed by a physical fence, for example to protect humans from the industrial robot.

As an alternative to a physical fence, some robot systems employ virtual safety borders to provide a safety configuration. Each virtual safety border is typically associated with a condition, for example that the industrial robot must not pass the virtual safety border. In this case, the robot system may also comprise a monitoring system supervising positions and movements of the industrial robot with respect to the virtual safety borders. If the safety configuration is violated by the industrial robot, the monitoring system can automatically stop the industrial robot to avoid an accident.

US 2016207198 A1 discloses a method for verifying one or more safety volumes for a movable mechanical unit positioned in an environment, wherein a world-coordinate system is defined in relation to the mechanical unit and in relation to the environment of the mechanical unit. The method includes storing a description of one or more safety volumes defined in relation to the world-coordinate system, and repeatedly: determining position and orientation of a portable display unit in relation to the world-coordinate system; determining a graphical representation of the safety volumes based on the description of the safety volumes and the position and orientation of the portable display unit; overlaying the graphical representation of the safety volumes on a view of the real mechanical unit and its environment to provide a composited augmented reality image; and displaying the augmented reality image on the portable display unit.

A safety configuration comprising virtual safety borders may be generated and visualized in a virtual environment. In the physical environment however, the virtual safety borders are invisible to a human. It is therefore often challenging to manually verify whether the virtual safety borders have been correctly positioned in relation to the industrial robot and any obstacles in the physical environment. Examples of such obstacles comprise fences, walls, tables and various other equipment.

Virtual safety borders generated in a virtual environment may not always be positioned as expected in a physical environment. The reasons for this may be many, for example that the environment including any obstacles therein are not modelled accurately enough. If the industrial robot starts operating based on a virtual environment that does not correspond to the real environment, severe accidents may occur. For this reason, the safety configuration is typically verified by an integrator before the intended operations of the industrial robot are initiated. The verification of the safety configuration when setting up an automation cell comprising the industrial robot is however a very time consuming step. Thus, designing a safety configuration in a virtual environment may be made rather quickly, but the verification that the virtual design correctly matches the real design is very time consuming and consequently costly.

### SUMMARY

One object of the present disclosure is to provide an improved method of handling safety of an industrial robot.

A further object of the present disclosure is to provide a method of handling safety of an industrial robot, which method enables an improved verification of a position of a virtual safety border in a physical environment.

A still further object of the present disclosure is to provide a method of handling safety of an industrial robot, which method enables an increased level of automation for verifying a position of a virtual safety border in a physical environment.

A still further object of the present disclosure is to provide a method of handling safety of an industrial robot, which method enables an improved safety handling in view of protective stops of the industrial robot.

A still further object of the present disclosure is to provide a method of handling safety of an industrial robot, which method is cost-efficient.

A still further object of the present disclosure is to provide a method of handling safety of an industrial robot, which method is less complicated.

A still further object of the present disclosure is to provide a method of handling safety of an industrial robot, which method efficient creation of a virtual safety border for the industrial robot.

A still further object of the present disclosure is to provide a method of handling safety of an industrial robot, which method solves several or all of the foregoing objects in combination.

A still further object of the present disclosure is to provide a control system for handling safety of an industrial robot, which control system solves one, several or all of the foregoing objects.

A still further object of the present disclosure is to provide a robot system solving one, several or all of the foregoing objects.

According to a first aspect, there is provided a method of handling safety of an industrial robot, the method comprising providing at least one virtual safety border defined in relation to the industrial robot, where each virtual safety border is associated with a condition to be fulfilled by the industrial robot; obtaining environment data of a physical environment of the industrial robot by means of an environment sensor; determining, by a control system, an obstacle position of an obstacle in the environment based on the environment data; and evaluating, by the control system, a border position of each virtual safety border with regard to the obstacle position.

By using the control system to evaluate the border position of each virtual safety border with regard to one or more obstacles in the environment based on the environment data, the one or more border positions in the physical environment can be automatically verified. By automating this verification, large time savings can be made. Since the time spent for the verification is reduced, also costs are reduced.

The industrial robot may comprise a stationary base and a manipulator movable in three or more axes relative to the base, such as in six or seven axes.

The one or more virtual safety borders may be generated in a virtual environment. The one or more virtual safety borders may be sent as a safety configuration, or as a part of a safety configuration, to a control system of the robot system. Each virtual safety border may be stationary in the environment during operation of the industrial robot. Thus, the industrial robot may be movable relative to the at least one virtual safety border. Alternatively, or in addition, each virtual safety border may be vertically oriented, e.g. extending vertically from a floor.

The at least one virtual safety border may define a virtual safety region. The virtual safety region may for example be a two-dimensional or a three-dimensional region in the environment. The virtual safety region may at least partly enclose the industrial robot and/or an obstacle in the environment.

Each virtual safety border may be a surface. The surface may be of various shapes, including curved and planar surfaces. According to one example, one virtual safety border may be cylindrical to enclose the industrial robot.

The conditions may be of various types. When a condition is triggered, a constraint may be imposed on the industrial robot. According to one example, the condition comprises a stop of the industrial robot. According to a further example, the condition comprises a limitation of an operation parameter of the industrial robot. Examples of operation parameters include speed, acceleration, force, torque, temperature and payload. According to a further example, the industrial robot is speed limited or stopped when an object other than the industrial robot appears between the virtual safety border and the industrial robot.

The method may be carried out with a robot system of any type according to the present disclosure. The robot system may comprise a monitoring system. The monitoring system may be configured to monitor movements of the industrial robot with respect to the at least one virtual safety border. The monitoring system may provide monitoring functions that can intervene to stop the industrial robot during operation if a condition associated with the virtual safety border is violated by the industrial robot. The monitoring system may comprise a monitoring controller and a monitoring device for monitoring the environment.

The environment sensor may comprise an electromagnetic sensor, such as a radar or a lidar, or a light sensor, such as a camera. The camera may be two-dimensional or three-dimensional.

The evaluation may comprise evaluating the border position with regard to the obstacle and at least one criterion. The method may further comprise approving or disapproving the border position based on the evaluation. The method may further comprise operating the industrial robot using the virtual safety border upon approval of the border position.

The evaluation of the border position may comprise determining whether any obstacle is positioned between the industrial robot and the virtual safety border. This evaluation may thus comprise determining whether any obstacle is positioned inside the virtual safety border. In this regard, an inside direction of the virtual safety border is a direction towards the industrial robot. Conversely, an outside direction of the virtual safety border is a direction away from the industrial robot.

The evaluation of the border position may comprise determining a safety distance between the virtual safety border and the obstacle when the virtual safety border is positioned between the industrial robot and the obstacle. The method may thus comprise determining whether any obstacle is positioned outside the virtual safety border, and determining the safety distance to this obstacle.

The at least one condition may comprise a protective stop of the industrial robot. In this case, the evaluation of the border position may further comprise evaluating the safety distance in view of a braking distance of the industrial robot for the protective stop. The evaluation of the safety distance may comprise comparing the safety distance and the braking distance from a common virtual safety border. In case the braking distance is larger than the safety distance, there is a risk that the industrial robot will collide with the obstacle when the protective stop is triggered by the industrial robot. In case the braking distance is equal to or smaller than the safety distance, the risk of collision is eliminated. This provides a very efficient evaluation of a safety configuration of the industrial robot. The braking distance for the protective stop may for example be determined based on simulations. Worst case scenarios may be used for these simulations, for example by using a maximum speed and/or a maximum payload of the industrial robot when the protective stop is triggered. Alternatively, a fixed value may be set for the braking distance, for example based on a rating and/or one or more operation parameters of the industrial robot.

According to a second aspect, there is provided a method of handling safety of an industrial robot, the method comprising obtaining environment data of a physical environment of the industrial robot by means of an environment sensor; determining, by a control system, an obstacle position of an obstacle in the environment based on the environment data; and defining, by the control system, at least one virtual safety border in relation to the industrial robot based on the obstacle position, the at least one virtual safety border being associated with a condition to be fulfilled by the industrial robot.

The environment sensor may be carried by the industrial robot. In this case, the method may further comprise moving the industrial robot in the environment to obtain the environment data by means of the environment sensor.

When carrying out the method according to this variant, the monitoring functions may optionally be temporarily suspended. In this way, the industrial robot can move through each virtual safety border without triggering the intervention by the monitoring system.

It is however also possible to provide one or more environment sensors external to the industrial robot. For example, a plurality of stationary environment sensors, such as cameras, may be arranged to monitor the environment to provide environment data.

According to a third aspect, there is provided a control system for handling safety of an industrial robot, the control system comprising at least one data processing device and at least one memory having at least one computer program stored thereon, the at least one computer program comprising program code which, when executed by the at least one data processing device, causes the at least one data processing device to perform the steps of providing at least one virtual safety border defined in relation to the industrial robot, where each virtual safety border is associated with a condition to be fulfilled by the industrial robot; obtaining environment data of a physical environment of the industrial robot from an environment sensor; determining an obstacle position of an obstacle in the environment based on the environment data; and evaluating a border position of each virtual safety border with regard to the obstacle position. The at least one computer program may further comprise program code which, when executed by the at least one data processing device, causes the at least one data processing device to perform, or command performance of, any step described herein.

The evaluation of the border position may comprise determining whether any obstacle is positioned between the industrial robot and the virtual safety border.

The evaluation of the border position may comprise determining a safety distance between the virtual safety border and the obstacle when the virtual safety border is positioned between the industrial robot and the obstacle.

The at least one condition may comprise a protective stop of the industrial robot. In this case, the evaluation of the border position may further comprise evaluating the safety distance in view of a braking distance of the industrial robot for the protective stop.

According to a fourth aspect, there is provided a control system for handling safety of an industrial robot, the control system comprising at least one data processing device and at least one memory having at least one computer program stored thereon, the at least one computer program comprising program code which, when executed by the at least one data processing device, causes the at least one data processing device to perform the steps of obtaining environment data of a physical environment of the industrial robot from an environment sensor; determining an obstacle position of an obstacle in the environment based on the environment data; and defining at least one virtual safety border in relation to the industrial robot based on the obstacle position, the at least one virtual safety border being associated with a condition to be fulfilled by the industrial robot. The at least one computer program may further comprise program code which, when executed by the at least one data processing device, causes the at least one data processing device to perform, or command performance of, any step described herein.

In any of the third and fourth aspects, the environment sensor may be carried by the industrial robot. In this case, the at least one computer program may comprise program code which, when executed by the at least one data processing device, causes the at least one data processing device to perform the step of commanding movement of the industrial robot in the environment to obtain the environment data by means of the environment sensor.

According to a fifth aspect, there is provided a robot system comprising the industrial robot, the environment sensor and a control system according to the third aspect and/or the fourth aspect. Each of the industrial robot and the environment sensor may be of any type as described herein.

The environment sensor may be carried by the industrial robot. Alternatively, the robot system may comprise one or more external environment sensors, either stationary or movable.

### BRIEF DESCRIPTION OF THE DRAWINGS

Further details, advantages and aspects of the present disclosure will become apparent from the following description taken in conjunction with the drawings, wherein:

FIG. 1: schematically represents a side view of a robot system;

FIG. 2: schematically represents a block diagram of the robot system;

FIG. 3: schematically represents a perspective view of the robot system, virtual safety borders, and an obstacle positioned partly inside the virtual safety borders;

FIG. 4: schematically represents a perspective view of the robot system where the obstacle is positioned outside the virtual safety borders;

and

FIG. 5: schematically represents a perspective view of a further example of a robot system, and the obstacle positioned outside the virtual safety borders.

### DETAILED DESCRIPTION

In the following, methods of handling safety of an industrial robot, a control system for handling safety of an industrial robot, and robot systems, will be described. The same or similar reference numerals will be used to denote the same or similar structural features.

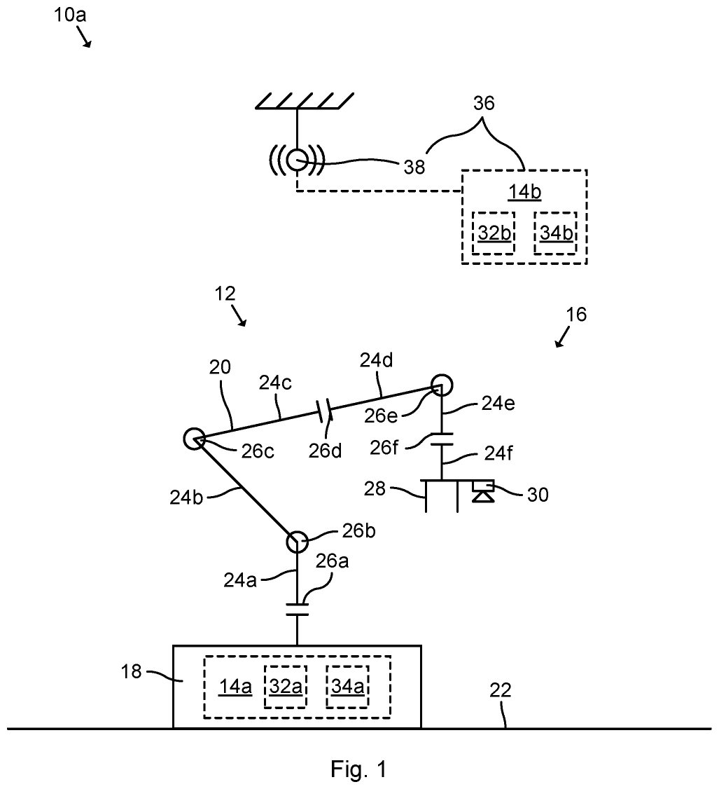

FIG. 1 schematically represents a side view of a robot system 10a. The robot system 10a comprises an industrial robot 12 and a robot controller 14a. The robot controller 14a is one example of a control system according to the present disclosure. The industrial robot 12 is positioned in a physical environment 16.

The industrial robot 12 comprises a stationary base 18 and a manipulator 20 movable relative to the base 18. The base 18 is here positioned on a floor 22. The manipulator 20 of this specific example comprises a first link 24a rotatable relative to the base 18 at a first axis 26a, a second link 24b rotatable relative to the first link 24a at a second axis 26b, a third link 24c rotatable relative to the second link 24b at a third axis 26c, a fourth link 24d rotatable relative to the third link 24c at a fourth axis 26d, a fifth link 24e rotatable relative to the fourth link 24d at a fifth axis 26e, and a sixth link 24f rotatable relative to the fifth link 24e at a sixth axis 26f.

The industrial robot 12 further comprises a tool 28, here exemplified as a gripper. The tool 28 is in this example fixed to the sixth link 24f. The manipulator 20 in FIG. 1 is a serial manipulator and the tool 28 is provided at a distal end of a kinematic chain thereof. The industrial robot 12 in FIG. 1 is however only one of many examples. The manipulator 20 may for example alternatively or additionally comprise one or more translational joints.

The robot system 10a further comprises a three-dimensional camera 30. The camera 30 is one example of an environment sensor according to the present disclosure. As shown in FIG. 1, the camera 30 is carried by the industrial robot 12. In this specific example, the camera 30 is positioned at a distal end of the manipulator 20, next to the tool 28.

The robot controller 14a is configured to control operations of the industrial robot 12. The robot controller 14a comprises a data processing device 32a and a memory 34a. The memory 34a comprises a computer program containing program code, which when executed by the data processing device 32a, causes the data processing device 32a to perform, or command performance of, various steps as described herein. The camera 30 is in signal communication with the robot controller 14a.

The robot system 10a of this example further comprises a monitoring system 36. The monitoring system 36 comprises a monitoring controller 14b and a monitoring device 38. The monitoring controller 14b is a further example of a control system according to the present disclosure. The monitoring controller 14b is configured to control operations of the monitoring system 36. The monitoring controller 14b comprises a data processing device 32b and a memory 34b. The memory 34b comprises a computer program containing program code, which when executed by the data processing device 32b, causes the data processing device 32b to perform, or command performance of, various steps as described herein. The monitoring controller 14b is in signal communication with the robot controller 14a.

The monitoring device 38 is here exemplified as a lidar but may be another type of sensor configured to detect movements of the industrial robot 12 within the environment 16. The monitoring device 38 is in signal communication with the monitoring controller 14b. The monitoring system 36 may comprise a plurality of such monitoring devices 38.

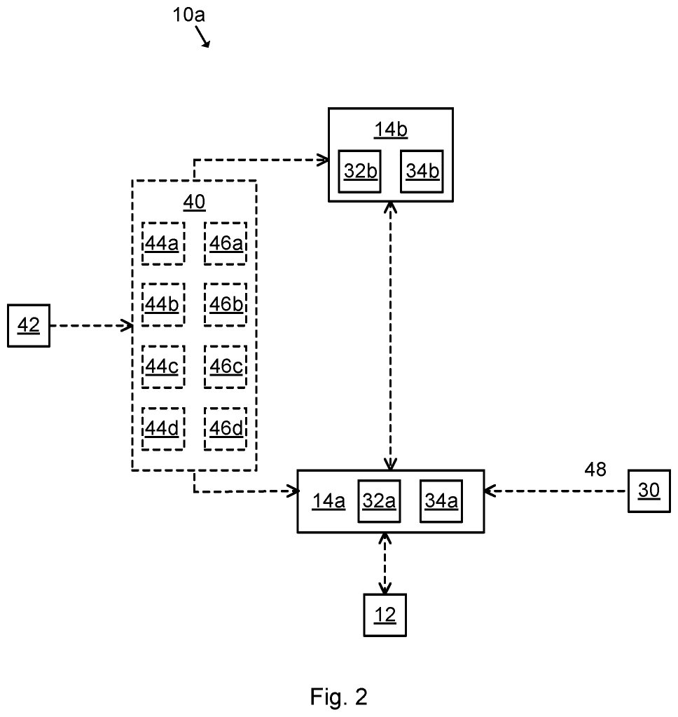

FIG. 2 schematically represents a block diagram of the robot system 10a. FIG. 2 shows that a safety configuration 40 for the industrial robot 12 is sent from a computer 42 to each of the robot controller 14a and the monitoring controller 14b. The safety configuration 40 of this specific and non-limiting example comprises four virtual safety borders 44a-44d and four conditions 46a-46d. Each virtual safety border 44a-44d is associated with one of the conditions 46a-46d.

A virtual design of the environment 16 including the safety configuration 40 may be created virtually, such as in RobotStudio® sold by ABB. The industrial robot 12 is then installed in the physical environment 16 along with any surrounding equipment. Examples of such equipment comprise CNC (computer numerical control) machines, conveyor belts, fences, walls and similar. Such equipment constitute examples of obstacles according to the present disclosure.

The camera 30 is configured to generate environment data 48 of the physical environment 16. As shown in FIG. 2, the camera 30 sends the environment data 48 to the robot controller 14a in this example. The robot controller 14a is configured to perform image processing of the environment data 48 to determine an obstacle position of an obstacle in the environment 16.

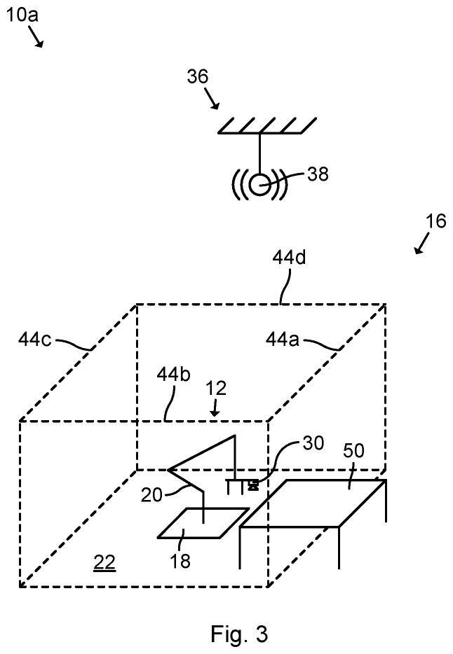

FIG. 3 schematically represents a perspective view of the robot system 10a. FIG. 3 shows the four virtual safety borders 44a-44d. FIG. 3 further shows a table 50. The table 50 is one example of an obstacle according to the present disclosure. The table 50 is positioned in the environment 16 of the industrial robot 12.

The virtual safety borders 44a-44d are invisible to a human. The virtual safety borders 44a-44d are stationary in the environment 16 and are defined in relation to the industrial robot 12. Thus, each virtual safety border 44a-44d has a corresponding border position. The virtual safety borders 44a-44d are here exemplified as four interconnected vertical and planar surfaces extending from the floor 22 and surrounding the industrial robot 12. The virtual safety borders 44a-44d provide a three-dimensional virtual safety region containing the industrial robot 12. As shown in FIG. 1, the table 50 is positioned partly inside this virtual safety region.

Each virtual safety border 44a-44d is associated with one of the conditions 46a-46d to be fulfilled by the industrial robot 12. In this example, the condition 46a-46d for each virtual safety border 44a-44d is a stop of the industrial robot 12. The industrial robot 12 is allowed to move freely inside the virtual safety borders 44a-44d, but the industrial robot 12 should be stopped if crossing any of the virtual safety borders 44a-44d.

During operation of the industrial robot 12, the monitoring system 36 monitors the environment 16 and movements of the industrial robot 12 in view of the safety configuration 40. If the conditions 46a-46d associated with the virtual safety borders 44a-44d are not met by the industrial robot 12, the monitoring controller 14b commands a protective stop of the industrial robot 12. With the introduction of the monitoring system 36 to the robot system 10a, no physical fence is needed. Instead, the safety supervision provided by the monitoring system 36 is used as protection.

According to one aspect of the method of handling safety of the industrial robot 12, the industrial robot 12 moves the camera 30 to make a three-dimensional scan of the environment 16 to provide environment data 48. The camera 30 may for example be moved inside the virtual safety borders 44a-44d to capture environment data 48 of the environment 16 both inside and outside of the virtual safety borders 44a-44d. Optionally, the monitoring functions provided by the monitoring system 36 may temporarily be suspended. In this way, the industrial robot 12 can move the camera 30 through the virtual safety borders 44a-44d for the purpose of obtaining further or alternative environment data 48 without triggering a safety reaction from the monitoring system 36.

In this example, the virtual safety borders 44a-44d have been set to provide a virtual safety region with a criterion that the industrial robot 12 should not encounter any obstacles inside the virtual safety region. However, as shown in FIG. 3, the table 50 is partly inside the virtual safety border 44a.

Based on the environment data 48, the robot controller 14a determines an obstacle position of the table 50. Since the robot controller 14a knows the border positions of the virtual safety borders 44a-44d, the robot controller 14a can conclude based on the environment data 48 that the table 50 is inside the virtual safety border 44a, i.e. between the industrial robot 12 and the virtual safety border 44a. The robot controller 14a thus automatically evaluates the border positions of the virtual safety borders 44a-44d in view of the obstacle position. This automation generates substantial time savings for an integration process. In response to detecting the table 50 inside the virtual safety border 44a, the robot controller 14a may issue, or command issuance of, an alarm notifying a user that the criterion of no obstacles inside the virtual safety borders 44a-44d is not met. Alternatively, or in addition, the border position of the virtual safety border 44a can be disapproved. In either way, collisions between the industrial robot 12 and the table 50 can be prevented. Optionally, it may be evaluated whether or not any obstacle within the virtual safety region is expected or not. In this case, the alarm may only be issued for unexpected obstacles. In this way, the intentional use of obstacles inside the virtual safety region is enabled. The determination of the obstacle position of the table 50 and the evaluation of the border positions of the virtual safety borders 44a-44d with regard to the obstacle position may alternatively be performed by the monitoring controller 14b or by another controller.

According to a further aspect of the method of handling safety of the industrial robot 12, environment data 48 of the environment 16 is obtained from the camera 30. The robot controller 14a then determines an obstacle position of one or more obstacles in the environment 16 based on the environment data 48. The robot controller 14a then defines at least one of the virtual safety borders 44a-44d in relation to the industrial robot 12 based on the one or more obstacle positions. Thus, the virtual safety borders 44a-44d can be created based on the environment data 48 as an alternative to creating the virtual safety borders 44a-44d entirely virtually. The same equipment for evaluating a border position of each virtual safety border 44a-44d can therefore also be used to create the virtual safety borders 44a-44d.

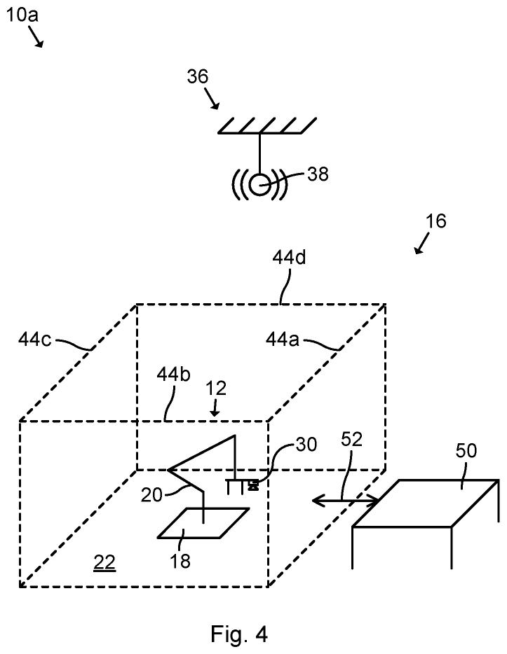

FIG. 4 schematically represents a perspective view of the robot system 10a. Mainly differences with respect to FIG. 3 will be described. As shown in FIG. 4, the table 50 is now positioned entirely outside the virtual safety border 44a, i.e. such that the virtual safety border 44a is positioned between the industrial robot 12 and the table 50.

According to one variant of the method of handling safety of the industrial robot 12, the industrial robot 12 moves the camera 30 to provide environment data 48 of the environment 16. Based on the environment data 48, the robot controller 14a determines an obstacle position of the table 50. Since the table 50 is outside the virtual safety border 44a, the robot controller 14a verifies that the criterion of no obstacles inside the virtual safety borders 44a-44d is met.

When an obstacle is detected outside the virtual safety border 44a, as with the table 50 shown in FIG. 4, the method further comprises determining a safety distance 52 between the virtual safety border 44a and the obstacle. The camera 30 is thus used to measure the safety distance 52 to the table 50. Since the robot controller 14a knows the border positions of the virtual safety borders 44a-44d and has determined the obstacle position of the table 50, the robot controller 14a can calculate the safety distance 52. According to one example, the safety distance 52 may be determined as the shortest distance between any point on the obstacle and any point on the virtual safety borders 44a-44d.

In this example, each condition 46a-46d is a so-called category-0 protective stop that will cause the monitoring system 36 to command an immediate braking of the industrial robot 12 when any part of the industrial robot 12 (e.g. the tool 28 thereof) crosses any of the virtual safety borders 44a-44d. The industrial robot 12 may for example trigger the condition 46a when reaching the virtual safety border 44a with a potentially high speed and/or a potentially high payload. This will cause the industrial robot 12 to move outside the virtual safety border 44a. The safety distance 52 is provided to make sure that the industrial robot 12 will never collide with the table 50 even in a worst case scenario, e.g. a protective stop triggered during high speed and high payload.

The method of this variant therefore further comprises evaluating the safety distance 52 in view of a braking distance of the industrial robot 12 for the protective stop. A braking distance for the industrial robot 12 may be determined for each virtual safety border 44a-44d, or even for several points on each virtual safety border 44a-44d. Such braking distances can be determined by means of simulations.

A criterion for the evaluation may be set as the braking distance should be equal to or shorter than the safety distance 52. By using the safety distance 52, it can be checked whether each virtual safety border 44a-44d is placed with correct spacing to any physical obstacles, such as the table 50, if a category-0 stop would occur. This has advantages in comparison with evaluating the safety distance 52 to an obstacle entirely virtually. This is because the relationship between the virtual safety border 44a and the table 50 may be different in the physical environment 16.

In the example in FIG. 4, the robot controller 14a concludes that the criterion of the safety distance 52 is met and thereby automatically verifies the virtual safety border 44a. In this way, verification of the virtual safety borders 44a-44d is made very efficient and collisions between the industrial robot 12 and any obstacle in the environment 16 is reliably prevented. In prior art solutions, such verification of safety distances 52 to make sure that the industrial robot 12 does not collide with external obstacles during a protective stop is very time consuming. By automating this step, many hours are saved for the integrators. When the camera 30 has scanned the environment 16 and the robot controller 14a has evaluated the border position of each virtual safety border 44a-44d in view of the table 50, the robot controller 14a can give a binary answer (“yes or no”) to whether or not the industrial robot 12 has sufficient safety distances 52 to any external obstacles in case of a protective stop.

A report may then be automatically generated based on the evaluations of the virtual safety borders 44a-44d. When the border positions of the virtual safety borders 44a-44d are approved, the industrial robot 12 is commanded to initiate its intended operation inside the virtual safety borders 44a-44d under supervision of the monitoring system 36.

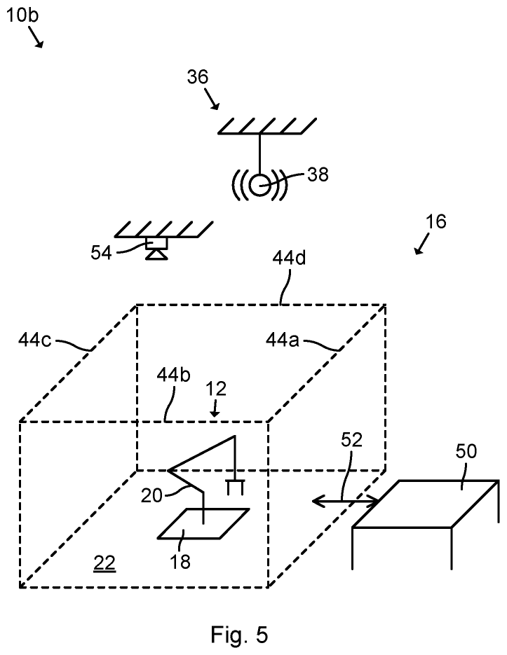

FIG. 5 schematically represents a perspective view of a further example of a robot system 10b. Similarly to FIG. 4, the table 50 is positioned outside the virtual safety borders 44a-44d in FIG. 5. The robot system 10b differs from the robot system 10a by comprising a stationary three-dimensional camera 54 (and no camera carried by the industrial robot 12). The camera 54 is a further example of an environment sensor according to the present disclosure. The camera 54 is in signal communication with the robot controller 14a. The position of the camera 54 relative to the industrial robot 12 is known. The robot system 10b can also carry out the methods as described herein.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A method of handling safety of an industrial robot, the method comprising:
providing at least one virtual safety border defined in relation to the industrial robot, where each virtual safety border is associated with a condition to be fulfilled by the industrial robot;
obtaining environment data of a physical environment of the industrial robot by means of an environment sensor;
determining, by a control system, an obstacle position of an obstacle in the environment based on the environment data; and
evaluating, by the control system, a border position of each virtual safety border with regard to the obstacle position.

2. The method according to claim 1, wherein the evaluation of the border position comprises determining whether any obstacle is positioned between the industrial robot and the virtual safety border.

3. The method according to claim 1, wherein the evaluation of the border position comprises determining a safety distance between the virtual safety border and the obstacle is positioned between the industrial robot and the obstacle.

4. The method according to claim 3, wherein the at least one condition comprises a protective stop of the industrial robot, and wherein the evaluation of the border position further includes evaluating the safety distance in view of a braking distance of the industrial robot for the protective stop.

5. A method of handling safety of an industrial robot, the method comprising:
obtaining environment data of a physical environment of the industrial robot by means of an environment sensor;
determining, by a control system, an obstacle position of an obstacle in the environment based on the environment data; and
defining, by the control system, at least one virtual safety border in relation to the industrial robot based on the obstacle position, the at least one virtual safety border being associated with a condition to be fulfilled by the industrial robot.

6. The method according to claim 1, wherein the environment sensor is carried by the industrial robot.

7. The method according to claim 6, further comprising moving the industrial robot in the environment to obtain the environment data by means of the environment sensor.

8. A control system for handling safety of an industrial robot, the control system comprising at least one data processing device and at least one memory having at least one computer program stored thereon, the at least one computer program having program code which, when executed by the at least one data processing device, causes the at least one data processing device to perform the steps of:
providing at least one virtual safety border defined in relation to the industrial robot, where each virtual safety border is associated with a condition to be fulfilled by the industrial robot;
obtaining environment data of a physical environment of the industrial robot from an environment sensor;
determining an obstacle position of an obstacle in the environment based on the environment data; and
evaluating a border position of each virtual safety border with regard to the obstacle position.

9. The control system according to claim 8, wherein the evaluation of the border position comprises determining whether any obstacle is positioned between the industrial robot and the virtual safety border.

10. The control system according to claim 8, wherein the evaluation of the border position comprises determining a safety distance between the virtual safety border and the obstacle when the virtual safety border is positioned between the industrial robot and the obstacle.

11. The control system according to claim 10, wherein the at least one condition comprises a protective stop of the industrial robot, and wherein the evaluation of the border position further includes evaluating the safety distance in view of a braking distance of the industrial robot for the protective stop.

12. A control system for handling safety of an industrial robot, the control system comprising at least one data processing device and at least one memory having at least one computer program stored thereon, the at least one computer program having program code which, when executed by the at least one data processing device, causes the at least one data processing device to perform the steps of:
obtaining environment data of a physical environment of the industrial robot from an environment sensor;
determining an obstacle position of an obstacle in the environment based on the environment data; and
defining at least one virtual safety border in relation to the industrial robot based on the obstacle position, the at least one virtual safety border being associated with a condition to be fulfilled by the industrial robot.

13. The control system according to any of claim 8, wherein the environment sensor is carried by the industrial robot, and wherein the at least one computer program comprises program code which, when executed by the at least one data processing device, causes the at least one data processing device to perform the step of commanding movement of the industrial robot in the environment to obtain the environment data by means of the environment sensor.

14. A robot system comprising an industrial robot, an environment sensor and a control system for handling safety of the industrial robot, the control system having at least one data processing device and at least one memory having at least one computer program stored thereon, the at least one computer program having program code which, when executed by the at least one data processing device, causes the at least one data processing device to perform the steps of:
providing at least one virtual safety border defined in relation to the industrial robot, where each virtual safety border is associated with a condition to be fulfilled by the industrial robot;
obtaining environment data of a physical environment of the industrial robot from an environment senor,
determining an obstacle position of an obstacle in the environment based on the environment data; and
evaluating a border position of each virtual safety border with regard to the obstacle position.

15. The robot system according to claim 14, wherein the environment sensor is carried by the industrial robot.

16. The method according to claim 2, wherein the evaluation of the border position comprises determining a safety distance between the virtual safety border and the obstacle when the virtual safety border is positioned between the industrial robot and the obstacle.

17. The method according to claim 2, wherein the environment sensor is carried by the industrial robot.

18. The control system according to claim 9, wherein the evaluation of the border position comprises determining a safety distance between the virtual safety border and the obstacle when the virtual safety border is positioned between the industrial robot and the obstacle.

19. The control system according to any of claim 9, wherein the environment sensor is carried by the industrial robot, and wherein the at least one computer program comprises program code which, when executed by the at least one data processing device, causes the at least one data processing device to perform the step of commanding movement of the industrial robot in the environment to obtain the environment data by means of the environment sensor.
